(19) United States
(12) Patent Application Publication
(10) Pub. No.: US 2023/0040808 A1
(43) Pub. Date: Feb. 9, 2023

(54) PHOTO-CURABLE RESIN COMPOSITION FOR THREE-DIMENSIONAL SHAPING

(71) Applicant: CANON KABUSHIKI KAISHA, Tokyo (JP)

(72) Inventor: Ryo Ogawa, kanagawa (JP)

(21) Appl. No.: 17/934,365

(22) Filed: Sep. 22, 2022

Related U.S. Application Data
(63) Continuation of application No. PCT/JP2021/013801, filed on Mar. 31, 2021.

(30) Foreign Application Priority Data
Apr. 7, 2020 (JP) 2020-068922
Mar. 19, 2021 (JP) 2021-046012

(51) Int. Cl. C08F 2/44; C08F 2/48; C08F 290/06; C08K 3/36; B29C 64/264; B29C 64/129; B33Y 10/00; B33Y 70/10; B33Y 80/00

(52) U.S. Cl. CPC C08F 2/44; C08F 2/48; C08F 290/067; C08K 3/36; B29C 64/264; B29C 64/129; B33Y 10/00; B33Y 70/10; B33Y 80/00; C08K 2003/2227

(57) ABSTRACT

A photo-curable resin composition for three-dimensional shaping including: a resin component (A) containing a (meth)acrylate compound (A1) represented by General Formula (1)

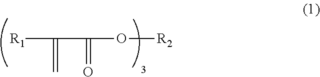

(where R₁ is a hydrogen atom or a methyl group, and R₂ is a linear, branched, or cyclic trivalent hydrocarbon group with one to eight carbon atoms which may have three or less heteroatoms), and a urethane (meth)acrylate compound (A2) having two or more radical-polymerizable functional groups; inorganic particles (B); and a photoradical polymerization initiator (C). 40% by mass or more and 90% by mass or less of the (meth)acrylate compound (A1) is contained in the resin component (A). 10% by mass or more and 60% by mass or less of the urethane (meth)acrylate compound (A2) is contained in the resin component (A).

### CROSS-REFERENCE TO RELATED APPLICATIONS

This application is a Continuation of International Patent Application No. PCT/JP2021/013801, filed Mar. 31, 2021, which claims the benefit of Japanese Patent Application No. 2020-068922, filed Apr. 7, 2020, and Japanese Patent Application No. 2021-046012, filed Mar. 19, 2021, all of which are hereby incorporated by reference herein in their entirety.

### BACKGROUND OF THE INVENTION

### Field of the Invention

The present invention relates to a photo-curable resin composition for three-dimensional shaping.

### Description of the Related Art

An optical three-dimensional shaping method has been known in which a step of selectively irradiating a photo-curable resin composition with light to form a cured resin layer such as to reproduce a predetermined three-dimensional shape is repeated to form a three-dimensionally shaped object being such cured resin layers laminated together. A representative example of this optical three-dimensional shaping method will be described below.

First, the liquid surface of a photo-curable resin composition stored in a container is selectively irradiated with light, such as an ultraviolet laser beam, such that a cross-sectional pattern of a three-dimensionally shaped object to be fabricated is depicted. As a result, a cured resin layer having the predetermined cross-sectional pattern is formed. Then, the photo-curable resin composition is supplied in an amount corresponding to a single layer onto this cured resin layer, and its liquid surface is irradiated with light along the next cross-sectional pattern. As a result, a new cured resin layer is integrally formed and laminated on the previously formed cured resin layer such that the they are continuous with each other. By repeating the above steps a predetermined number of times, a predetermined three-dimensionally shaped object can be fabricated.

Recent three-dimensional shaping methods are capable of quickly manufacturing a three-dimensional object. Thus, in an application of shaping a mold for injection molding, the recent three-dimensional shaping methods have been expected to achieve a cost reduction and efficient prototype fabrication and drawing attention. In such applications, shaped objects are required to have high temperature endurance and high rigidity. Japanese Patent Application Laid-Open No. 2005-60673 discloses that an object having both high temperature endurance and high rigidity can be obtained by using silica microparticles and nanoparticles, a radical-polymerizable compound, and a cation-polymerizable compound.

In the case of molding an engineering plastic by injection molding, the injection molding requires an even higher flexural modulus and flexural strength, and the technique of Japanese Patent Application Laid-Open No. 2005-60673 is insufficient.

An object of the present invention is to provide a photo-curable resin composition preferable for three-dimensional shaping with which a shaped object usable as a mold for injection molding can be obtained.

### SUMMARY OF THE INVENTION

A photo-curable resin composition of the present invention is characterized in that the photo-curable resin composition includes:

a resin component (A) containing a (meth)acrylate compound (A1) represented by General Formula (1) below

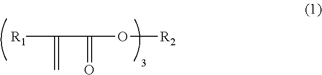

(where R₁ is a hydrogen atom or a methyl group, and R₂ is a linear, branched, or cyclic trivalent hydrocarbon group with one to eight carbon atoms which may have three or less heteroatoms), and a urethane (meth)acrylate compound (A2) having two or more radical-polymerizable functional groups;

inorganic particles (B); and

a photoradical polymerization initiator (C), wherein

40% by mass or more and 90% by mass or less of the (meth)acrylate compound (A1) is contained in the resin component (A), and

10% by mass or more and 60% by mass or less of the urethane (meth)acrylate compound (A2) is contained in the resin component (A).

Further features of the present invention will become apparent from the following description of exemplary embodiments with reference to the attached drawing.

### BRIEF DESCRIPTION OF THE DRAWINGS

FIG. 1s a diagram illustrating an example of the configuration of a shaping apparatus using a photo-curable resin composition of the present invention.

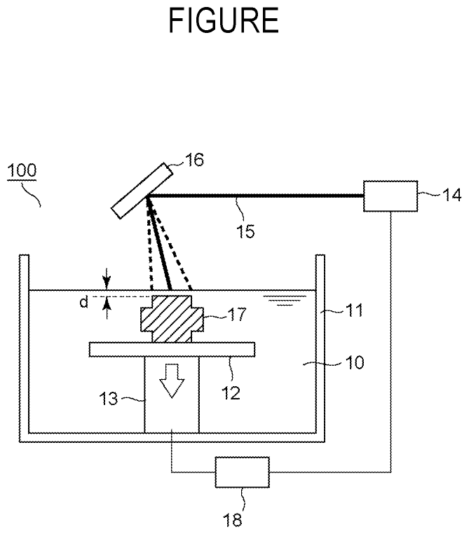

### DESCRIPTION OF THE EMBODIMENTS

An embodiment of the present invention will be described below. Note that the embodiment to be described below is merely one embodiment of the present invention, and the present invention is not limited to this embodiment.

### <<Photo-curable Resin Composition>>

### <Resin Component (Polymerizable Compound)>

A composition of the present invention contains, as a resin component (A), a component (A1) being a radial-polymerizable (meth)acrylate compound and a component (A2) being a radial-polymerizable urethane (meth)acrylate. Here, a (meth)acrylate means an acrylate or a methacrylate. The composition of the present invention may contain another resin component (A3) as the resin component (A) in addition to the component (A1) and the component (A2). Assuming that the total of the component (A1), the component (A2), and the component (A3) is 100 parts by mass, the total of the component (A1) and the component (A2) is preferably 40 parts by mass or more and 100 parts by mass or less, more preferably 60 parts by mass or more and 100 parts by mass or less from the viewpoint of flexural modulus and flexural strength, and even more preferably 80 parts by mass or more and 100 parts by mass or less from the viewpoint of heat resistance.

### [Component (A1): (Meth)acrylate Compound]

The (meth)acrylate compound as the component (A1) is represented by General Formula (1) below.

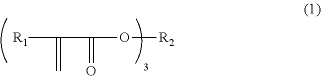

[R₁: a hydrogen atom or a methyl group, R₂: a linear, branched, or cyclic trivalent hydrocarbon group with one to eight carbon atoms which may have three or less heteroatoms]

The (meth)acrylate compound (A1) has three groups of one or more kinds selected from among an acryloyl group and a methacryloyl group within a single molecule. A methacryloyl group with a methyl group as R₁ is preferable from the viewpoint of flexural modulus and heat resistance. The three (meth)acryloyl groups within a single molecule may be the same or different. R₂, or the trivalent hydrocarbon group, preferably has one to eight carbon atoms since the heat resistance of a shaped object will drop if the number of atoms is nine or more, and may be linear, branched, or cyclic. R₂ preferably has three or less heteroatoms since having four or more heteroatoms increases polarity and induces a rise in the viscosity of the composition and a deterioration of the shaped object due to water absorbency.

Specifically, the component (A1) includes, but is not limited to, 1,3,5-triacryloylhexahydro-1,3,5-triazine, pentaerythritol tri(meth)acrylate, propane-1,2,3-triol tri(meth)acrylate, trimethylolpropane tri(meth)acrylate, and so on. Pentaerythritol tri(meth)acrylate, propane-1,2,3-triol tri(meth)acrylate, and trimethylolpropane tri(meth)acrylate, which are liquids at normal temperature, are preferable from the viewpoint of the heat resistance and handling of a shaped object formed by shaping the composition. Also, in order for the three-dimensionally shaped object to be accurate, the viscosity is required to be low. Hence, it is preferable not to contain a polar group such as a hydroxy group, and trimethylolpropane tri(meth)acrylate and propane-1,2,3-triol tri(meth)acrylate are more preferable.

40% by mass or more and 90% by mass or less of the component (A1) is contained in the resin component (A) for the purpose of using the composition for three-dimensionally shaped objects that need a high heat resistance of 200° C. or higher suitable for molds for injection molding. Also, in the case of using the composition for injection molding of a super engineering plastic, such as a liquid crystal polymer, PEEK, or polyetherimide, even higher heat resistance is required. In this case, 70% by mass or more and 90% by mass or less of the component (A1) is desirably contained in the resin component (A).

### [Component (A2): Urethane (Meth)Acrylate]

The resin component (A) of the present invention also contains a urethane (meth)acrylate (A2) having two or more radical-polymerizable functional groups.

In the present invention, a urethane (meth)acrylate refers to one having a urethane bond and a group(s) of one or more kinds selected from among a radial-polymerizable acryloyl group and methacryloyl group (hereinafter referred to as “(meth)acryloyl groups”) within its molecular chain. The urethane (meth)acrylate (A2) preferably has two or more groups of one or more kinds selected from the (meth)acryloyl groups. In particular, a urethane (meth)acrylate having two (meth)acryloyl groups is preferable for the purpose of improving the flexural strength. In the present invention, high heat resistance and flexural strength can be achieved by polymerizing the urethane (meth)acrylate (A2) with another or polymerizing the urethane (meth)acrylate (A2) with the (meth)acrylate compound of the component (A1) to cure them.

The urethane (meth)acrylate (A2) can be obtained using a publicly known method. For example, there is a method in which the urethane (meth)acrylate (A2) is obtained through a reaction of a polyalcohol and an isocyanate compound with hydroxy acrylate. There is also a method in which the urethane (meth)acrylate (A2) is obtained through a reaction of a polyalcohol with a (meth)acrylate having an isocyanate group. In this case, a low molecular weight polyalcohol or an isocyanate compound having two isocyanate groups may be used as a chain extender.

Examples of the polyalcohol include low molecular weight polyalcohols such as neopentyl glycol, 3-methyl-1,5-pentanediol, ethylene glycol, propylene glycol, 1,4-butanediol, 1,6-hexanediol, trimethylolpropane, pentaerythritol, tricyclodecane dimethylol, and bis-[hydroxymethyl]-cyclohexane.

Examples also include polyester polyols obtained through a reaction between a polyalcohol and a polybasic acid (e.g., succinic acid, phthalic acid, hexahydrophthalic anhydride, terephthalic acid, adipic acid, azelaic acid, tetrahydrophthalic anhydride, and so on), polycaprolactone polyols obtained through a reaction between a polyalcohol and ε-caprolactone, polycarbonate polyols (e.g., a polycarbonate diol obtained through a reaction between 1,6-hexanediol and diphenyl carbonate, and so on), and polyether polyols. The polyether polyols include polyethylene glycol, polypropylene glycol, polytetramethylene glycol, ethylene oxide-modified bisphenol A, and so on.

For use as a resin composition for three-dimensional shaping, it is important to suppress a rise in viscosity when the urethane (meth)acrylate (A2) and inorganic particles (B) are mixed. To suppress the rise in the viscosity of the resin composition for three-dimensional shaping, it is preferable to use a polyester polyol or a urethane (meth)acrylate obtained by using a polyester polyol so that physical interactions between the surfaces of the inorganic particles (B) and hydrogen bonds and the like can be suppressed.

Examples of the isocyanate compound include isocyanate compounds such as isophorone diisocyanate, hexamethylene diisocyanate, tolylene diisocyanate, xylene diisocyanate, diphenylmethane-4,4′-diisocyanate, dicyclopentanyl isocyanate, adducts of these isocyanate compounds, multimers of these isocyanates, and so on.

Examples of a hydroxy (meth)acrylate compound include pentaerythritol tri(meth)acrylate, pentaerythritol di(meth)acrylate, dipentaerythritol penta(meth)acrylate, dipentaerythritol tetra(meth)acrylate, hydroxyethyl (meth)acrylate, hydroxypropyl (meth)acrylate, hydroxybutyl (meth)acrylate, dimethylol cyclohexyl mono(meth)acrylate, hydroxy caprolactone (meth)acrylate, and so on.

Examples of the (meth)acrylate having an isocyanate group include 2-(meth)acryloyloxyethyl isocyanate, 2-isocyanate ethyl (meth)acrylate, 2-(2-(meth)acryloyloxyethyloxy)ethyl isocyanate, 1,1-(bis(meth)acryloyloxymethyl)ethyl isocyanate, and so on.

While a mass average molecular weight Mw of the urethane (meth)acrylate (A2) is not particularly limited, it is preferably 600 or more and 10,000 or less, more preferably 1,000 or more and 8,000 or less, and even more preferably 1,500 or more and 7,000 or less from the viewpoint of the viscosity of the composition. Note that the mass average molecular weight Mw is a value in terms of polystyrene measured by GPC (gel permeation chromatography).

For the urethane (meth)acrylate (A2), there is a product commercially available as a urethane resin or the like, and this commercially available product may be used in the present invention.

To achieve an improvement in the flexural strength of a shaped object of the composition, which is an advantageous effect of the present invention, 10% by mass or more and 50% by mass or less of the component (B) is preferably contained in the resin component. From the viewpoint of the viscosity of the composition and the flexural strength of the shaped object, 15% by mass or more and 35% by mass or less of the component (B) is more preferably contained.

### [Component (A3): Another Resin Component]

The resin component (A) forming the composition of the present invention may contain a polymerizable compound other than the component (A1) and the component (A2) as another resin component (A3) and may contain, for example, a cation-polymerizable compound as represented by an epoxy compound.

For example, a (meth)acrylate compound or the like may be contained as the polymerizable compound other than the component (A1) and the component (A2).

The (meth)acrylate compound includes a monofunctional (meth)acrylate compound having one (meth)acryloyl group within a molecule, a multifunctional (meth)acrylate compound having two or more (meth)acryloyl groups within a molecule, and the like. In the present invention, polymerizable (meth)acrylate compounds are usable as long as they are polymerizable by a common method. One or more kinds of monofunctional (meth)acrylate compounds and multifunctional (meth)acrylate compounds can be mixed as desired and used.

The monofunctional (meth)acrylate compounds include methyl (meth)acrylate, ethyl (meth)acrylate, n-butyl (meth)acrylate, isobutyl (meth)acrylate, t-butyl (meth)acrylate, 2-ethylhexyl (meth)acrylate, n-octyl (meth)acrylate, i-octyl (meth)acrylate, lauryl (meth)acrylate, stearyl (meth)acrylate, cyclohexyl (meth)acrylate, isobornyl (meth)acrylate, adamantyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminomethyl (meth)acrylate, phenyl cellosolve (meth)acrylate, dicyclopentenyl (meth)acrylate, dicyclopentenyloxyethyl (meth)acrylate, biphenyl (meth)acrylate, 2-hydroxyethyl (meth)acryloyl phosphate, phenyl (meth)acrylate, phenoxyethyl (meth)acrylate, phenoxypropyl (meth)acrylate, benzyl (meth)acrylate, and so on.

The multifunctional (meth)acrylate compounds include ethylene glycol di(meth)acrylate, diethylene glycol di(meth)acrylate, triethylene glycol di(meth)acrylate, tetraethylene glycol di(meth)acrylate, nonaethylene glycol di(meth)acrylate, 1,3-butylene glycol di(meth)acrylate, 1,4-butanediol di(meth)acrylate, dimethyloltricyclodecane di(meth)acrylate, neopentyl glycol di(meth)acrylate, 1,6-hexamethylene di(meth)acrylate, hydroxypivalic acid ester neopentyl glycol di(meth)acrylate, tris (meth)acryloxyethyl isocyanurate, pentaerythritol tetra(meth)acrylate, ditrimethylolpropane tetraacrylate, dipentaerythritol tetra(meth)acrylate, dipentaerythritol penta(meth)acrylate, dipentaerythritol hexa(meth)acrylate, and so on.

As the epoxy compound, an epoxy compound having an alicyclic structure with excellent heat resistance is more preferable from the viewpoint of heat resistance flexural strength. Specifically, 3′,4′-epoxycyclohexylmethyl, 3′,4′-epoxy cyclohexanecarb oxylate, 2,2-bis(3,4-epoxycyclohexyl)propane, methylene bis (3,4-epoxycyclohexane), and so on. Also, a compound having an oxetanyl group may be contained in order to improve the polymerization rate.

Assuming that the total of the component (A1), the component (A2), and the component (A3) is 100 parts by mass, 20 parts by mass or less of the other resin component (A3) is preferably contained (20% by mass or less in the resin component (A)). If the content of the component (A3) is more than 20 parts by mass, any of the properties of flexural modulus, flexural strength, and heat resistance tends to deteriorate.

### <Component (B): Inorganic Particles>

The composition of the present invention contains inorganic particles as the component (B). The inorganic particles are preferably particles made of one of silicon dioxide (silica), a metal oxide, diamond, a multiple metal oxide, a metal-compound semiconductor, or a metal. Examples of the metal oxide include aluminum oxide (alumina), titanium oxide, niobium oxide, tantalum oxide, zirconium oxide, zinc oxide, magnesium oxide, tellurium oxide, yttrium oxide, indium oxide, tin oxide, indium tin oxide, and so on. Examples of the multiple metal oxide include lithium niobate, potassium niobate, lithium tantalate, and so on. Examples of the metal compound semiconductor include metal sulfides such as zinc sulfide and cadmium sulfide, zinc selenide, cadmium selenide, zinc telluride, cadmium telluride, and so on. Examples of the metal include gold and so on. It is also possible to use so-called core-shell inorganic particles which are inorganic particles of one kind coated with another inorganic component. Among the above, silica and alumina are preferable since these have low refractive indexes, thereby suppressing scattering of light, are advantageous for the dimensional accuracy of the object to be three-dimensionally shaped, and are hard, thereby giving a high flexural modulus to the shaped object when mixed.

Also, from the viewpoint of obtaining a high flexural modulus, 20% by volume or more and 65% by volume or less of the inorganic particles (B) is preferably contained in the composition. When the content of the inorganic particles (B) is 20% by volume or more, it is possible to obtain a sufficient flexural modulus required in the case of using the shaped object as a mold for injection molding. When the content of the inorganic particles is equal to or less than 65% by volume, at which the inorganic particles are closely packed, the particles contact one another to a moderate extent, and sufficient flexural strength can be obtained. From the viewpoint of the balance between the viscosity of the resin composition and the elastic modulus of the shaped object, the content of the inorganic particles is more preferably 40% by volume or more and 65% by volume or less and even more preferably 50% by volume or more and 65% by volume or less. With a thermogravimetric analyzer, the percentage by volume of the inorganic particles in the composition can be calculated from the density of the shaped object of the inorganic particles and the resin component based on the percentage by mass of the residual inorganic component obtained by combusting the shaped object of the composition under an oxygen stream.

In the case where the surfaces of the inorganic particles have been modified, the inorganic particles are less likely to aggregate. Accordingly, the inorganic particles are less likely to settle over time, and mechanical properties are less likely to be deteriorated by the presence of aggregates inside the shaped object. Also, the smaller the number of aggregates present, the smaller the apparent particle size and the smaller the scattering of light. Thus, when the composition is used in three-dimensional shaping, the applied light is scattered less and less unnecessary portions are cured. Accordingly, the accuracy of the shaped object is less likely to be deteriorated.

The surfaces of the inorganic particles (B) preferably have an organic group in order to prevent aggregation of the inorganic particles and uniformly disperse the inorganic particles. Examples of the organic group include a phenyl group, a vinyl group, an epoxy group, a (meth)acryloyl group, an amino group, a ureido group, a mercapto group, an isocyanate group, alkyl groups having one to six carbon atoms, and so on, and these organic groups may have substituents. These organic groups are preferably bound or adsorbed to the surfaces of the inorganic particles via a bond formed of an oxygen atom, a silicon atom, or one or more atoms selected from a nitrogen atom, a sulfur atom, and a hydrogen atom. The organic group can be introduced by modifying the surfaces of the inorganic particles with a silane coupling agent or an organic component such as an isocyanate compound. The silane coupling agent includes phenyltrimethoxysilane, vinyltrimethoxysilane, epoxytrimethoxysilane, methacrylic trimethoxysilane, aminotrimethoxysilane, ureidotrimethoxysilane, mercaptotrimethoxysilane, isocyanate trimethoxysilane, acryltrimethoxysilane, and so on. The isocyanate compound includes 2-(meth)acryloyloxyethyl isocyanate, 2-isocyanate ethyl (meth)acrylate, 2-(2-(meth)acryloyloxyethyloxy)ethyl isocyanate, 1,1-(bis(meth)acryloyloxymethyl)ethyl isocyanate, benzenesulfonyl isocyanate, 4-(trifluoromethyl)phenyl isocyanate, phenethyl isocyanate, and so on.

Considering the dispersibility in the composition, the inorganic particles (B) preferably have a (meth)acryloyl group. When the inorganic particles (B) has a (meth)acryloyl group, the inorganic particles are dispersed uniformly. Thus, when the composition is shaped, a shaped object having a high dimensional accuracy can be obtained.

Also, in the case where the surfaces of the inorganic particles (B) are modified, the amount of the organic component of the inorganic particles is preferably 0.1% by mass or more and less than 20% by mass and more preferably 0.5% by mass or more and less than 10% by mass from the viewpoint of the flexural modulus and heat resistance of the shaped object. Regarding the amount of the organic component, the percentage by mass of the organic component can be derived with a thermogravimetric analyzer by combusting the inorganic particles under an oxygen gas stream and combusting the organic component under the oxygen gas stream.

The shape of the inorganic particles (B) may be in any shape such as a spherical shape, an ellipsoidal shape, a flat shape, or a rod shape. Here, the viscosity of the composition is preferably 0.1 mPa·s or more and 20000 mPa·s or less from the viewpoint of the dimensional accuracy of the object to be three-dimensionally shaped. The closer the shape of the inorganic particles to a spherical shape, the smaller their surface area and therefore the smaller the interaction between the composition and the inorganic particles. Accordingly, the viscosity is less prone to rise. Moreover, the closer the shape of the inorganic particles to a spherical shape, the smaller their surface area and the smaller the amount of the modifier required to cover their surfaces. Accordingly, physical properties of the shaped object are less prone to be deteriorated. Hence, the inorganic particles (B) preferably have high sphericity, and the sphericity is preferably 0.7 or more, more preferably 0.8 or more, and even more preferably 0.85 or more. As the sphericity, a value calculated from the equation below is used.

(Sphericity)={4π×(Projected Area of Particle)÷(Circumferential Length of Projected Image of Particle)²}

Alternatively, the sphericity may be similarly calculated from the equation below.

(Sphericity)={Diameter of Circle Having Same Area as Projected Area of Particle÷Diameter of Circle having Same Circumferential Length as Circumferential Length of Projected Image of Particle}

Since each single layer to be laminated in three-dimensional shaping usually has a thickness in a range of from 20 μm to 200 μm the average particle size of the inorganic particles (B) is preferably less than the thickness of a single layer. Moreover, the average particle size is preferably 0.1 μm or more so that the composition can have appropriate viscosity. Thus, the average particle size of the inorganic particles (B) is preferably 0.2 μm or more and 20 μm or less and more preferably 0.5 μm or more and 10 μm or less. The average particle size of the inorganic particles (B) is even more preferably 0.5 μm or more and 2 μm or less from the viewpoint of the scattering of light.

While the method of manufacturing spherical inorganic particles as described above is not particularly limited, it is desirable to use a method in which, for example, silicon powder or aluminum powder is combusted to manufacture particles by the VMC (Vaporized Metal Combustion) method since in this way particles with particularly high sphericity can be obtained.

### <Polymerization Initiators>

### (Component (C): Photoradical Polymerization Initiator)

In the present invention, the composition is irradiated in particular with an active energy ray to be cured. For this purpose, the composition contains a photoradical polymerization initiator (C).

Photoradical polymerization initiators are mainly classified into an intramolecular cleavage type and a hydrogen abstraction type. When the intramolecular cleavage-type radical polymerization initiator absorbs light of a particular wavelength, a bond at a particular site is cleaved, and a radical is generated at the cleaved site and serves as a polymerization initiator to initiate the polymerization of a radial-polymerizable resin component. On the other hand, the hydrogen abstraction type absorbs light of a particular wavelength to be brought into an excited state, and the resultant excited species causes a hydrogen abstraction reaction from a hydrogen donor present in the surroundings to generate a radical, which serves as a polymerization initiator to initiate the polymerization of a radical-polymerizable resin component.

Alkylphenone-based photoradical polymerization initiators, acylphosphine oxide-based photoradical polymerization initiators, and oxime ester-based photoradical polymerization initiators have been known as intramolecular cleavage-type photoradical polymerization initiators. These are of a type that generates a radical species through the α-cleavage of a bond adjacent to a carbonyl group.

Benzyl methyl ketal-based photoradical polymerization initiators, α-hydroxyalkylphenone-based photoradical polymerization initiators, aminoalkylphenone-based photoradical polymerization initiators, and so on have been known as alkylphenone-based photoradical polymerization initiators. Examples of specific compounds include, but are not limited to: 2,2′-dimethoxy-1,2-diphenylethan-1-one (Omnirad (R) 651, manufactured by BASF) and so on as the benzyl methyl ketal-based photoradical polymerization initiators; 2-hydroxy-2-methyl-1-phenylpropan-1-one (Darocure (R) 1173, manufactured by IGM RESINS B.V.), 1-hydroxycyclohexyl phenyl ketone (Omnirad (R) 184, manufactured by IGM RESINS B.V.), 1-[4-(2-hydroxyethoxy)phenyl]-2-hydroxy-2-methyl-1-propan-1-one (Omnirad (R) 2959, manufactured by IGM RESINS B.V.), 2-hydroxy-1-{4-[4-(2-hydroxy-2-methylpropionyl)benzyl]phenyl}-2-methylpropan-1-one (Omnirad (R) 127, manufactured by IGM RESINS B.V.), and so on as the α-hydroxyalkylphenone-based photoradical polymerization initiators; and 2-methyl-1-(4-methylthiophenyl)-2-morpholinopropan-1-one (Omnirad (R) 907, manufactured by IGM RESINS B.V.), 2-benzylmethyl-2-dimethylamino-1-(4-morpholinophenyl)-1-butanone (Omnirad (R) 369, manufactured by IGM RESINS B.V.), and so on as the aminoalkylphenone-based photoradical polymerization initiators.

The acylphosphine oxide-based photoradical polymerization initiators include, but are not limited to, 2,4,6-trimethylbenzoyldiphenylphosphine oxide (Lucirin (R) TPO, manufactured by IGM RESINS B.V.), bis(2,4,6-trimethylbenzoyl)-phenylphosphine oxide (Omnirad (R) 819, manufactured by IGM RESINS B.V.), and so on.

The oxime ester-based photoradical polymerization initiators include, but are not limited to, (2E)-2-(benzoyloxyimino)-1-[4-(phenylthio)phenyl]octan-1-one (Omnirad (R) OXE-01, manufactured by IGM RESINS B.V.) and so on.

The hydrogen abstraction-type radical polymerization initiators include, but are not limited to, anthraquinone derivatives such as 2-ethyl-9,10-anthraquinone and 2-t-butyl-9,10-anthraquinone, and thioxanthone derivatives such as isopropylthioxanthone and 2,4-diethylthioxanthone.

Two or more kinds of photoradical polymerization initiators (C) may be used in combination, or one kind of photoradical polymerization initiator (C) may be used alone. The amount of the photoradical polymerization initiator to be added is preferably 0.1 part by mass or more and 15 parts by mass or less and more preferably 0.1 part by mass or more and 10 parts by mass or less with respect to 100 parts by mass of the radical-polymerizable resin component. When the amount of the photoradical polymerization initiator is 0.1 part by mass or more, the polymerization will be sufficient. When the amount of the photoradical polymerization initiator is 15 parts by mass or less, light transmissiveness will be sufficient and the polymerization will be uniform.

### [Other Polymerization Initiators]

The composition of the present invention may contain a thermal radical polymerization initiator in order to promote the polymerization reaction by a heat treatment after shaping. The thermal radical polymerization initiator is not particularly limited as long as it generates a radical by heating, and a conventionally known compound can be used. Preferred examples thereof may include azo-based compounds, peroxides, persulfuric acid salts, and so on. The azo-based compounds include 2,2′-azobisisobutyronitrile, 2,2′-azobis(methyl isobutyrate), 2,2′-azobis-2,4-dimethylvaleronitrile, 1,1′-azobis(1-acetoxy-1-phenylethane), and so on. The peroxides include benzoyl peroxide, di-t-butylbenzoyl peroxide, t-butyl peroxypivalate, di(4-t-butylcyclohexyl)peroxydicarbonate, and so on. The persulfuric acid salts include persulfuric acid salts such as ammonium persulfate, sodium persulfate, and potassium persulfate.

The amount of the thermal radical polymerization initiator to be added is preferably 0.1 part by mass or more and 15 parts by mass or less and more preferably 0.1 part by mass or more and 10 parts by mass or less with respect to 100 parts by mass of the radical-polymerizable resin component. When the amount of the thermal radical polymerization initiator to be added is 15 parts by mass or less, the molecular weight is appropriate, and sufficient physical properties can be obtained.

Also, when a cation-polymerizable resin component such as an epoxy compound is contained, a photoacid generator may be contained. Examples of the photoacid generator include a photo-cationic polymerization initiator that generates an acid capable of initiating a cationic polymerization upon irradiation with an active energy ray, such as an ultraviolet ray. Specifically, for example, an onium salt in which the cation part is aromatic sulfonium, aromatic iodonium, aromatic diazonium, aromatic ammonium, thianthrenium, thioxanthenium, or [cyclopentadienyl(1-methyl ethylbenzene)-Fe] cation, and the anion part is BF4-, PF6-, SbF6-, or [BX4]- (where X represents a phenyl group substituted with at least two fluorine atoms or trifluoromethyl groups) may be used alone or two or more kinds thereof may be used in combination. The content of the photoacid generator may be 0.1 part by mass or more and 15 parts by mass or less and more preferably 0.1 part by mass or more and 10 parts by mass or less with respect to 100 parts by mass of the cation-polymerizable resin component.

### <Other Components>

The composition of the present invention may contain various additives as other optional components as long as the object and advantageous effects of the present invention are not impaired. Such additives include: a resin that does not cause a polymerization reaction, such, for example, as an epoxy resin, polyurethane, polybutadiene, polychloroprene, polyester, styrene-butadiene block copolymer, polysiloxane, petroleum resin, xylene resin, ketone resin, or cellulose resin; an engineering plastic such as polycarbonate, modified polyphenylene ether, polyamide, polyacetal, polyethylene terephthalate, polybutylene terephthalate, ultra-high molecular weight polyethylene, polyphenylsulfone, polysulfone, polyarylate, polyether imide, polyether ether ketone, polyphenylene sulfide, polyethersulfone, polyamide imide, liquid crystal polymer, polytetrafluoroethylene, polychlorotrifluoroethylene, or polyvinylidene fluoride; a reactive monomer such as a fluorine-based oligomer, silicone-based oligomer, polysulfide-based oligomer, fluorine-containing monomer, or a siloxane structure-containing monomer; a soft metal such as gold, silver, or lead; a layered crystal structure substance such as graphite, molybdenum disulfide, tungsten disulfide, boron nitride, graphite fluoride, calcium fluoride, barium fluoride, lithium fluoride, silicon nitride, or molybdenum selenide; a polymerization inhibitor such as phenothiazine or 2,6-di-t-butyl-4-methylphenol; a photosensitizer such as a benzoin compound, acetophenone compound, anthraquinone compound, thioxanthone compound, ketal compound, benzophenone compound, tertiary amine compound, or xanthone compound; a polymerization initiation aid; a leveling agent; a wettability improver; a surfactant; a plasticizer; an UV absorber; a silane coupling agent; an inorganic filler other than the inorganic particles (B) described above; a pigment; a dye; an antioxidant; a flame retardant; a thickener; a defoamer; and so on.

### <<Cured Object>>

The composition of the present invention is usable as a photo-curable resin composition with which a cured object such as a three-dimensionally shaped object can be obtained by curing its resin with light. The composition of the present invention is useful particularly in the case of using the three-dimensionally shaped object as a resin mold for injection molding and in the case of using the shaped object as a member that needs a high heat resistance of 200° C. or higher.

### <<Method of Manufacturing Three-Dimensionally Shaped Object>>

By containing the photoradical polymerization initiator (C), the composition of the present invention is preferably usable in optical three-dimensional shaping methods. Shaped objects may be fabricated by using any conventionally known optical three-dimensional shaping method and apparatus. A representative example of a preferable optical three-dimensional shaping method is an object manufacturing method using stereolithography which includes a step of placing a photo-curable resin composition in the form of a layer, and a step of irradiating the curable resin composition in the form of a layer with an optical energy based on slice data of a shaping model to thereby cure the curable resin composition. There are mainly two types, free surface method and constrained surface method.

FIGURE illustrates an example of the configuration of a stereolithography apparatus 100 using the free surface method. The stereolithography apparatus 100 has a vessel 11 filled with a liquid photo-curable resin composition 10. Inside the vessel 11, a shaping stage 12 is provided such as to be vertically movable by a driving shaft 13. An active energy ray 15 for curing the photo-curable resin composition 10 emitted from a light source 14 has its irradiation position changed by a galvanometer mirror 16 controlled by a controller 18 in accordance with slice data and is scanned over the surface of the vessel 11. In FIGURE, the scanning rage is illustrated with the bold broken lines.

A thickness d of the photo-curable resin composition 10 to be cured by the active energy ray 15 is a value determined based on settings at the time of generating the slice data and affects the accuracy of the shaped object to be obtained (the reproducibility of the three-dimensional shape data on the object to be shaped). The thickness d is achieved by the controller 18 controlling the amount of driving of the driving shaft 13.

First, the controller 18 controls the driving shaft 13 based on the settings to thereby supply the photo-curable resin composition onto the stage 12 to the thickness d. Based on the slice data, the liquid curable resin composition on the stage 12 is selectively irradiated with the active energy ray such that a cured layer having a desired pattern will be obtained. As a result, the cured layer is formed. Thereafter, the stage 12 is moved in the direction of the outlined arrow to thereby supply the uncured curable resin composition onto the surface of the cured layer to the thickness d. Then, the active energy ray 15 is applied based on the slice data, so that a cured object integrated with the previously formed cured layer is formed. By repeating this step of forming layers by curing, a target three-dimensionally shaped object 17 can be obtained.

The active energy ray to be used for the manufacture may include an ultraviolet ray, electron beam, X ray, and radiation. Among these, an ultraviolet ray having a wavelength of 300 nm or more and 450 nm or less is preferably used from an economic viewpoint. As the light source for that ultraviolet ray, an ultraviolet laser (e.g., Ar laser or He-Cd laser), mercury lamp, xenon lamp, halogen lamp, fluorescent lamp, or the like can be used. Among these, the laser light source is preferably employed since the energy level can be increased to shorten the shaping time, and moreover the light convergence property is so good that high shaping accuracy can be obtained.

In the formation of each cured resin layer with a predetermined shape pattern via irradiation of a shaping surface made of the composition with an active energy ray, the cured resin layer may be formed by a dot-drawing method or a line-drawing method using an active energy ray, such as a laser beam, converged into a dot shape or a line shape. Alternatively, a shaping method may be employed in which each cured resin layer is formed by irradiating the shaping surface with an active energy ray in a planar shape through a planar drawing mask formed by arranging a plurality of micro-optical shutters, such as liquid crystal shutters or digital micro-mirror shutters.

Also, a stereolithography apparatus using the constrained surface method has a configuration in which the stage 12 of the stereolithography apparatus 100 in FIGURE is provided such as to pull a shaped object upward above the liquid surface, and a light irradiation unit is provided under the vessel 11. A representative example of shaping by the constrained surface method is as follows. First, the support surface of a support stage provided such as to be capable of being raised and lowered and the bottom surface of a vessel storing the curable resin composition are placed with a predetermined distance therebetween, and the curable resin composition is supplied between the support surface of the support stage and the bottom surface of the vessel. Thereafter, from the bottom surface side of the vessel storing the curable resin composition, a laser light source or a projector selectively irradiates the curable resin composition between the support surface of the stage and the bottom surface of the vessel with light according to slice data. By the light irradiation, the curable resin composition between the support surface of the stage and the bottom surface of the vessel is cured, so that a solid cured resin layer is formed. Then, the support stage is raised to thereby pull the cured resin layer off the bottom surface of the vessel.

Thereafter, the height of the support stage is adjusted such as to leave the predetermined distance between the cured layer formed on the support stage and the bottom surface of the vessel. Then, light is selectively applied similarly to the previous step. As a result, between the cured resin layer and the bottom surface of the vessel, a new cured resin layer is formed which is integrated with the previously formed cured resin layer. Then, this step is repeated a predetermined number of times with the light irradiation pattern changed or not changed. As a result, a three-dimensionally shaped object being a plurality of cured resin layers laminated together is shaped.

The three-dimensionally shaped object thus obtained is taken out of the apparatus, and the unreacted composition remaining on the surface is removed. Then, cleaning is performed if necessary. Here, the cleaning agent may include: alcohol-based organic solvents as represented by alcohols such as isopropyl alcohol and ethyl alcohol; ketone-based organic solvents as represented by acetone, ethyl acetate, and methyl ethyl ketone; and aliphatic organic solvents as represented by terpenes. Note that after the cleaning with the cleaning agent, post-curing may be performed by light irradiation or heat irradiation (heat treatment) if necessary. The post-curing can cure the composition that may be left unreacted and remain on the surface and inside of the three-dimensionally shaped object, and hence can prevent the surface of the shaped object from being sticky and also improve the initial strength of the shaped object.

### EXAMPLES

The present invention will be specifically described below with reference to Examples. However, the present invention is not limited these Examples.

### <Evaluation Method>

An evaluation method will be described below.

### [Evaluation of Inorganic Particles]

With an electron microscope, the inorganic particles were observed, and their images were captured. Image processing was performed on the images, and the average particle size and the sphericity were derived. Moreover, using a thermogravimetric analyzer (Thermo Plus TG 8120, manufactured by Rigaku Corporation), the inorganic particles were combusted under an air stream, and the percentage by mass of the inorganic matter in the inorganic particles (non-volatile inorganic matter content) was derived from the smallest value of mass decrease.

### [Viscosity of Photo-Curable Resin Compositions]

Using a rotary rheometer (MCR-302, manufactured by Anton Paar GmbH), the viscosity of the solution was measured by following JIS Z8803 “Methods for viscosity measurement of liquid”. 2000 mPa·s or less was defined as “A”, more than 2000 mPa·s and 10000 mPa s or less was defined as “B”, more than 10000 mPa·s and 10000 mPa·s or less was defined as “C”, and more than 20000 mPa s was defined as “D”.

### [Evaluation of Mechanical Properties]

As an evaluation of mechanical properties, a bend test was performed by following JIS K6911-1995 “Testing methods for thermosetting plastics” to measure the flexural modulus and the flexural strength. For the measurement, a tensile tester (manufactured by A&D Company, Limited, product name “TENSILON Universal Material Testing Instrument RTF-1250”) was used.

### [Evaluation of Heat Resistance]

As an evaluation of the heat resistance, a load deflection test was performed by following JIS K6911-1995 “Testing methods for thermosetting plastics” to measure the deflection temperature under load. For the measurement, a load deflection tester (manufactured by Toyo Seiki Seisaku-sho, Ltd., product name “No.533 HDT Tester 3M-2”) was used.

### [Accuracy of Three-Dimensional Photo-Shaping]

With a caliper, 4-mm thickness measurement was performed on the shaped object. 4±0.1 mm was defined as “A”, 4±0.3 mm was defined as “B”, and other cases including failure to make a shaped object were defined as “C”.

### <Materials>

The materials used in Examples are listed below. As the component (A1), the following were used.

(A1) (Meth)acrylate compound represented by General Formula (1)

(Meth)acrylate compound (A1-1): trimethylolpropane trimethacrylate (manufactured by Tokyo Chemical Industry Co., Ltd.)

(Meth)acrylate compound (A1-2): glycerin triacrylate (product name Aronix (registered trademark) M-930, manufactured by Toagosei Co., Ltd.)

As the component (A2), the following were used. Note that “molecular weight” means the mass average molecular weight.

(A2) Urethane (meth)acrylate having two or more radical-polymerizable functional groups

### [Compounds Having No Polycarbonate Structure]

Urethane (meth)acrylate (A2-1): SHIKOH (registered trademark) UV-7550, trifunctional, molecular weight=2400, manufactured by Mitsubishi Chemical Corporation (having a polyether polyol structure)
Urethane (meth)acrylate (A2-2): UX-6101, molecular weight=6000, manufactured by Nippon Kayaku Co., Ltd. (having a polyether polyol structure and a polyester polyol)
Urethane (meth)acrylate (A2-3): UX-8101, molecular weight=3000, manufactured by Nippon Kayaku Co., Ltd. (having a polyether polyol structure and a polyester polyol)
Urethane (meth)acrylate (A2-4): EBECRYL (registered trademark) 4265, molecular weight=650, manufactured by DAICEL-ALLNEX LTD. (having a polyether polyol structure)

### [Compounds Having Polycarbonate Structure]

Urethane (meth)acrylate (A2-5): PC-2T, molecular weight=11000, manufactured by KSM Co., LTD.

(B) Inorganic Particles

As the component (B), the following were used.
Silica particles (B-1): ADMAFINE SC5500-SMJ (surface-modified with a methacryloyl group, non-volatile inorganic matter content=99% by mass or more), average particle size=1.6 μm, sphericity=0.88, manufactured by Admatechs Company Limited
Silica particles (B-2): ADMAFINE SC2500-SMJ (surface-modified with a methacryloyl group, non-volatile inorganic matter content=99% by mass or more), average particle size=0.5 μm, sphericity=0.90, manufactured by Admatechs Company Limited
Alumina particles (B-3): ADMAFINE AO-502 (surface-modified with a methacryloyl group, non-volatile inorganic matter content=99% by mass or more), average particle size=0.70 μm, sphericity=0.87, manufactured by Admatechs Company Limited
Alumina particles (B-4): aluminum oxide (α-Phase) (no surface modification, non-volatile inorganic matter content=99.9% by mass or more), average particle size=1 μm, sphericity=0.68, manufactured by Soekawa Kagaku K.K

(C): Photoradical Polymerization Initiator)

As the component (C), bis(2,4,6-trimethylbenzoyl)-phenylphosphine oxide (Omnirad (R) 819, manufactured by IGM RESINS RV) was used.

(A3): Another Resin Component

As the component (A3), the following multifunctional acrylates were used.
Resin component (A3-1): A-BPE-10, ethoxylated bisphenol A diacrylate, molecular weight=776, manufactured by SHIN-NAKAMURA CHEMICAL Co., Ltd.
Resin component (A3-2): pentaerythritol tetraacrylate, manufactured by Tokyo Chemical Industry Co., Ltd.

### Example 1

70 parts by mass of the (meth)acrylate (A1-1), 30 parts by mass of the urethane (meth)acrylate (A2-1), and 0.5 part by mass of the photoradical polymerization initiator (C) were mixed. Thereafter, the silica particles (B-1) were added in several batches to reach 50% by volume, followed by mixing with an agitator. As a result, a photo-curable resin composition was obtained.

The prepared composition was set in a three-dimensional shaping apparatus using the constrained surface method, and shaped into a piece measuring 10 mm in height, 4 mm in width, and 80 mm in length by the three-dimensional shaping apparatus to thereby obtain a test piece to be evaluated. The obtained test piece was heated at a predetermined temperature to thereby anneal it, and then subjected to various tests. Table 1 shows the evaluation results.

### Examples 2 to 18 and Comparative Examples 1 to 7

Compositions were prepared and evaluated similarly to Example 1 except that the compositions were changed to those shown in Table 1. Tables 1 and 2 show the results.

TABLE 1

| | | | | Examples | | | | | | | | | |
|---|---|---|---|---|---|---|---|---|---|---|---|---|---|
| | | | | 1 | 2 | 3 | 4 | 5 | 6 | 7 | 8 | 9 | 10 |
| Constitu- | Resin | Compo- | Kind | A1-1 | A1-1 | A1-1 | A1-1 | A1-1 | A1-1 | A1-1 | A1-1 | A1-1 | A1-1 |
| tion of | Compo- | nent | Content | 70 | 70 | 70 | 70 | 70 | 70 | 80 | 70 | 70 | 70 |
| Compo- | nent | (A1) | [Parts | | | | | | | | | | |
| sition | (A) | | by Mass] | | | | | | | | | | |
| | | Compo- | Kind | A2-1 | A2-1 | A2-1 | A2-2 | A2-2 | A2-2 | A2-2 | A2-3 | A2-4 | A2-5 |
| | | nent | Content | 30 | 30 | 30 | 30 | 30 | 30 | 20 | 30 | 30 | 30 |
| | | (A2) | [Parts | | | | | | | | | | |
| | | | by Mass] | | | | | | | | | | |
| | | Compo- | Kind | — | — | — | — | — | — | — | — | — | — |
| | | nent | Content | 0 | 0 | 0 | 0 | 0 | 0 | 0 | 0 | 0 | 0 |
| | | (A3) | [Parts | | | | | | | | | | |
| | | | by Mass] | | | | | | | | | | |

| | | | | | | | | | | | |
|---|---|---|---|---|---|---|---|---|---|---|---|
| Component | Kind | B-1 | B-2 | B-3 | B-1 | B-1 | B-1 | B-1 | B-1 | B-1 | B-1 |
| (B) | Content | 50 | 50 | 50 | 50 | 30 | 40 | 50 | 50 | 50 | 50 |
| | [Parts | | | | | | | | | | |
| | by Mass] | | | | | | | | | | |
| Component | Content | 0.5 | 0.5 | 0.5 | 0.5 | 0.5 | 0.5 | 0.5 | 0.5 | 0.5 | 0.5 |
| (C) | [Parts | | | | | | | | | | |
| | by Mass] | | | | | | | | | | |

| Evaluation Results | Viscosity | B | B | B | B | A | A | B | B | B | B |
|---|---|---|---|---|---|---|---|---|---|---|---|
| | Flexural | 11.4 | 10.8 | 10.5 | 12.8 | 5.7 | 7.4 | 11.2 | 12.9 | 10.2 | 11.3 |
| | Modulus (GPa) | | | | | | | | | | |
| | Flexural | 73.5 | 65.6 | 60.9 | 101.3 | 84.1 | 76.2 | 73.2 | 79 | 76.2 | 144.8 |
| | Strength (MPa) | | | | | | | | | | |
| | Deflection | >290 | >290 | >290 | >290 | 282 | 226 | 265 | >290 | >290 | >290 |
| | Temperature | | | | | | | | | | |
| | under | | | | | | | | | | |
| | Load (° C.) | | | | | | | | | | |
| | Accuracy of | A | A | A | A | A | A | A | A | A | A |
| | Three- | | | | | | | | | | |
| | dimensional | | | | | | | | | | |
| | Shaping | | | | | | | | | | |

| | | | | Examples | | | | | | | |
|---|---|---|---|---|---|---|---|---|---|---|---|
| | | | | 11 | 12 | 13 | 14 | 15 | 16 | 17 | 18 |
| Constitu- | Resin | Compo- | Kind | A1-1 | A1-1 | A1-1 | A1-1 | A1-1 | A1-2 | A1-1 | A1-1 |
| tion of | Compo- | nent | Content | 70 | 70 | 40 | 50 | 90 | 70 | 70 | 70 |
| Compo- | nent | (A1) | [Parts | | | | | | | | |
| sition | (A) | | by Mass] | | | | | | | | |
| | | Compo- | Kind | A2-5 | A2-2 | A2-1 | A2-1 | A2-1 | A2-2 | A2-2 | A2-2 |
| | | nent | Content | 30 | 30 | 60 | 50 | 10 | 30 | 30 | 10 |
| | | (A2) | [Parts | | | | | | | | |
| | | | by Mass] | | | | | | | | |
| | | Compo- | Kind | — | — | — | — | — | — | — | A3-1 |
| | | nent | Content | 0 | 0 | 0 | 0 | 0 | 0 | 0 | 20 |
| | | (A3) | [Parts | | | | | | | | |
| | | | by Mass] | | | | | | | | |

| | | | | | | | | | |
|---|---|---|---|---|---|---|---|---|---|
| Component | Kind | B-1 | B-1 | B-1 | B-1 | B-1 | B-1 | B-1 | B-1 |
| (B) | Content | 30 | 20 | 40 | 40 | 40 | 40 | 65 | 50 |
| | [Parts | | | | | | | | |
| | by Mass] | | | | | | | | |
| Component | Content | 0.5 | 0.5 | 0.5 | 0.5 | 0.5 | 0.5 | 0.5 | 0.5 |
| (C) | [Parts | | | | | | | | |
| | by Mass] | | | | | | | | |

| | | | | | | | | | |
|---|---|---|---|---|---|---|---|---|---|
| Evaluation Results | Viscosity | A | A | C | B | A | B | B | A |

| | | | | | | | | |
|---|---|---|---|---|---|---|---|---|
| Flexural | 6.1 | 5.2 | 7 | 7.6 | 7.5 | 7.2 | 11.8 | 10.5 |
| Modulus (GPa) | | | | | | | | |
| Flexural | 60.9 | 61.1 | 85.7 | 70 | 60 | 107.1 | 63.2 | 62.7 |
| Strength (MPa) | | | | | | | | |
| Deflection | 266 | >290 | >290 | >290 | >290 | >290 | >290 | >290 |
| Temperature | | | | | | | | |
| under | | | | | | | | |
| Load (° C.) | | | | | | | | |
| Accuracy of | A | A | B | A | A | A | B | A |
| Three- | | | | | | | | |
| dimensional | | | | | | | | |
| Shaping | | | | | | | | |

TABLE 2

| | | | | Comparative Examples | | | | | |
|---|---|---|---|---|---|---|---|---|---|
| | | | | 1 | 2 | 3 | 4 | 5 | 6 |
| Constitution | Resin | Component | Kind | A1-1 | A1-1 | A1-1 | — | A1-1 | A1-1 |
| of Composition | Component (A) | (A1) | Content [Parts | 70 | 100 | 70 | 0 | 30 | 95 |
| | | | by Mass] | | | | | | |
| | | Component | Kind | — | — | — | — | B-1 | B-2 |
| | | (A2) | Content [Parts | 0 | 0 | 0 | 0 | 70 | 5 |
| | | | by Mass] | | | | | | |
| | | Component | Kind | A3-1 | — | A3-2 | A3-1 | — | — |
| | | (A3) | Content [Parts | 30 | 0 | 30 | 100 | 0 | 0 |
| | | | by Mass] | | | | | | |

| | | | | | | | |
|---|---|---|---|---|---|---|---|
| Component (B) | Kind | B-1 | B-1 | B-1 | B-4 | B-1 | — |
| | Content [Parts | 50 | 50 | 50 | 50 | 40 | 0 |
| | by Mass] | | | | | | |
| Component (C) | Content [Parts | 0.5 | 0.5 | 0.5 | 0.5 | 0.5 | 0.5 |
| | by Mass] | | | | | | |

| Evaluation Results | Viscosity | A | A | B | C | C | D |
|---|---|---|---|---|---|---|---|
| | Flexural | 10.6 | 10.8 | — | — | 4.2 | — |
| | Modulus (GPa) | | | | | | |
| | Flexural Strength | 42.9 | 8 | — | — | 65.7 | — |
| | (MPa) | | | | | | |
| | Deflection | >290 | 263 | — | — | 115 | — |
| | Temperature | | | | | | |
| | under Load (° C.) | | | | | | |
| | Accuracy of | A | A | C | C | B | C |
| | Three- | | | | | | |
| | dimensional | | | | | | |
| | Shaping | | | | | | |

As shown in Table 1, in all of Examples 1 to 18, curable resin compositions favorable for shaping were obtained. As indicated by the evaluation results of the test pieces created by the three-dimensional shaping apparatus from the curable resin compositions of the present invention, the test pieces consisting of the curable resin compositions containing 20% by volume or more and 65% by volume or less of the inorganic particles (B) had a flexural modulus of 5 GPa or more, where was good. Also, the flexural modulus improved further such that the flexural modulus was 7 GPa or more when the content of the inorganic particles (B) was 40% by volume or more, and the flexural modulus was 10 GPa or more when the content of the inorganic particles (B) was 50% by volume or more. This indicates that the curable resin compositions of the present invention were more preferable for shaped objects that require high rigidity such as resin molds for injection molding. Thus, it has become clear that the content of the inorganic particles (B) is preferably 20% by volume or more and 65% by volume or less from the viewpoint of shapability and elastic modulus.

Regarding the test pieces created by the three-dimensional shaping apparatus from the curable resin compositions of the present invention, as indicated by Examples 1 to 18, all of the curable resin compositions exhibited a flexural strength of 60 MPa or higher, which is strength preferable for applications such as resin molds.

The test pieces created by the three-dimensional shaping apparatus from the curable resin compositions of the present invention in Examples 1 to 18 all exhibited a heat resistance of 200° C. or higher, indicating that the curable resin compositions are preferable for applications requiring high heat resistance, such as resin molds. In Comparative Example 6, the polymerization shrinkage at the time of shaping was so severe that the accuracy was significantly deteriorated, and an evaluation could not be made. This is considered due to the excess amount of the component (A1). In Comparative Example 5, the heat resistance was not sufficient for use as a resin mold. This is considered due to the excess amount of the component (A2). It has now become clear that the amount of the component (A1) needs to be 40 parts by mass or more and 90 parts by mass or less and the amount of the component (A2) needs to be 10 parts by mass or more and 60 parts by mass or less from the viewpoint of heat resistance and shapability.

In Examples 1 and 3 to 9, the viscosity was good at the time of shaping with the three-dimensional shaping apparatus, and the shaped objects had high dimensional accuracy as well. In Embodiment 2, in which the silica particles (B-2) having a small average particle size of 0.5 were used as the component (B), the viscosity slightly rose but the dimensional accuracy of the shaped object was good. However, the accuracy was slightly lower than those in Examples 1 and 3 to 9. Similarly, in Examples 10 to 11, in which the urethane (meth)acrylate (A2-5) having a polycarbonate structure was used as the component (A2), the viscosity rose presumably due to an interaction between the inorganic particles, but the accuracy of the shaped objects was good. However, the accuracy tended to be slightly lower than those in Examples 1 and 3 to 9.

The kind of the component (A1) in Example 16 differs from that in the other Examples. It is now clear that, regardless of which of one of the components is used as the component (A1), the shaped object has sufficient mechanical properties, heat resistance, and shapability for a resin mold.

In Comparative Example 1, in which the multifunctional acrylate (A3-1) having no urethane structure was used in place of the component (A2), the flexural modulus, the heat resistance, and the shaping accuracy were good but the flexural strength dropped.

In Comparative Example 2, the component (A2) was not used, and only the component (A1) was used. It is clear that this significantly deteriorates the flexural strength although the accuracy of the shaped object itself was good.

In Comparative Example 3, in which the multifunctional acrylate (A3-2) having no urethane structure was used in place of the component (A2), the fluidity of the composition was lost when the composition was prepared. It is therefore impossible to fabricate a test piece with the three-dimensional shaping apparatus.

In Comparative Example 4, the components (A1) and (A2) are not contained, and the alumina particles (B-4) not surface treated and having no organic group on their surfaces were used as the component (B). Thus, the inorganic particles did not get dispersed and settled. This made it impossible to obtain a good composition and perform shaping.

According to the present invention, it is possible to provide a photo-curable resin composition preferable for three-dimensional shaping with which a shaped object having good heat resistance, elastic modulus, and flexural strength and usable as a mold for resin injection molding can be formed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A photo-curable resin composition characterized in that the photo-curable resin composition comprises:
a resin component (A) containing a (meth)acrylate compound (A1) represented by General Formula (1) below 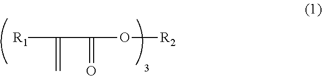
where R₁ is a hydrogen atom or a methyl group, and R₂ is a linear, branched, or cyclic trivalent hydrocarbon group with one to eight carbon atoms which may have three or less heteroatoms, and a urethane (meth)acrylate compound (A2) having two or more radical-polymerizable functional groups;
inorganic particles (B); and
a photoradical polymerization initiator (C), wherein
40% by mass or more and 90% by mass or less of the (meth)acrylate compound (A1) is contained in the resin component (A), and
10% by mass or more and 60% by mass or less of the urethane (meth)acrylate compound (A2) is contained in the resin component (A).

2. A photo-curable resin composition characterized in that the photo-curable resin composition comprises:
a resin component (A) containing a (meth)acrylate compound (A1) represented by General Formula (1) below 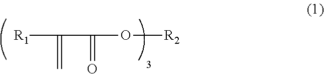
(where R₁ is a hydrogen atom or a methyl group, and R₂ is a linear, branched, or cyclic trivalent hydrocarbon group with one to eight carbon atoms which may have three or less heteroatoms), a urethane (meth)acrylate compound (A2) having two or more radical-polymerizable functional groups, and a polymerizable resin component (A3) other than the (meth)acrylate compound (A1) and the urethane (meth)acrylate compound (A2);
inorganic particles (B); and
a photoradical polymerization initiator (C), wherein
20% by mass or less of the polymerizable resin component (A3), which is other than the (meth)acrylate compound (A1) and the urethane (meth)acrylate compound (A2), is contained in the resin component (A),
40% by mass or more and 90% by mass or less of the (meth)acrylate compound (A1) is contained in the resin component (A), and
10% by mass or more and 60% by mass or less of the urethane (meth)acrylate compound (A2) is contained in the resin component (A).

3. The photo-curable resin composition according to claim 1, wherein an average particle size of the inorganic particles (B) is 0.5 μm or more and 10 μm or less and sphericity of the inorganic particles is 0.85 or more.

4. The photo-curable resin composition according to claim 2, wherein an average particle size of the inorganic particles (B) is 0.5 μm or more and 10 μm or less and sphericity of the inorganic particles is 0.85 or more.

5. The photo-curable resin composition according to claim 1, wherein the (meth)acrylate compound (A1) is one selected from the group consisting of 1,3,5-triacryloylhexahydro-1,3,5-triazine, pentaerythritol tri(meth)acrylate, and trimethylolpropane trimethacrylate.

6. The photo-curable resin composition according to claim 1, wherein the urethane (meth)acrylate compound (A2) is a urethane (meth)acrylate having two (meth)acryloyl groups.

7. The photo-curable resin composition according to claim 1, wherein the inorganic particles (B) are at least one selected from the group consisting of silica and alumina.

8. The photo-curable resin composition according to claim 1, wherein 20% by volume or more and 65% by volume or less of the inorganic particles (B) is contained.

9. The photo-curable resin composition according to claim 1, wherein 50% by volume or more and 65% by volume or less of the inorganic particles (B) is contained.

10. The photo-curable resin composition according to claim 1, wherein the inorganic particles (B) have an organic group on surfaces thereof.

11. The photo-curable resin composition according to claim 10, wherein the organic group is a (meth)acryloyl group.

12. The photo-curable resin composition according to claim 10, wherein an amount of an organic component of the inorganic particles (B) is 0.1% by mass or more and less than 20% by mass.

13. The photo-curable resin composition according to claim 1, wherein an average particle size of the inorganic particles (B) is 0.5 μm or more and 2 μm or less.

14. The photo-curable resin composition according to claim 1, wherein a mass average molecular weight of the urethane (meth)acrylate compound (A2) is 600 or more and 10,000 or less.

15. The photo-curable resin composition according to claim 1, wherein viscosity of the photo-curable resin composition is 0.1 mPa·s or more and 20000 mPa·s or less.

16. A cured object formed by curing the photo-curable resin composition according to claim 1.

17. The cured object according to claim 16, wherein a flexural modulus of the cured object is 5 GPa or more, and flexural strength of the cured object is 60 MPa or more.

18. A method of manufacturing a three-dimensional object by using stereolithography, the method comprising:
a step of placing a photo-curable resin composition in a form of a layer; and
a step of irradiating the photo-curable resin composition in the form of a layer with an opticalenergy based on slice data of a shaping model to thereby cure the photo-curable resin composition, wherein
the photo-curable resin composition is the photo-curable resin composition according to claim 1.

19. The method of manufacturing a three-dimensional object according to claim 18, further comprising a step of performing a heat treatment on a shaped object obtained by the irradiation with the opticalenergy.

20. The method of manufacturing a three-dimensional object according to claim 18, wherein the opticalenergy is light applied from a laser light source or a projector.
